(19) United States
(12) Patent Application Publication
(10) Pub. No.: US 2026/0073044 A1
(43) Pub. Date: Mar. 12, 2026

(54) SYSTEM AND METHOD FOR AUTOMATED ANOMALY DETECTION

(71) Applicant: ABLUVA PRIVATE LIMITED, PUNE (IN)

(72) Inventor: Amit Kumar GAUTAM, PUNE (IN)

(21) Appl. No.: 19/248,491

(22) Filed: Jun. 25, 2025

Related U.S. Application Data
(60) Provisional application No. 63/664,742, filed on Jun. 27, 2024.

(51) Int. Cl. G06F 21/55

(52) U.S. Cl. CPC G06F 21/554; G06F 2221/034

(57) ABSTRACT

A system and method for automated anomaly detection is described. The method includes identifying inherent characteristics or tags associated with the one or more entities. The characteristics or tags may be ranked or contextualized based on one or more global factors or actor-based factors. The method further includes contextualize actor behaviour considered over a period of time or sessions. The method further includes measuring context changes and context overlaps and quantifying the dynamics of the actor behaviour using one or more Al/ML models. Further, the method includes performing dynamic patching and dynamically modeling the changes in actor behaviour over time in order to detect anomalies.

### FIELD OF THE INVENTION

The present disclosure relates to anomaly detection. More particularly, the present disclosure relates to a system and a method for automated anomaly detection based on characterisation of entities being accessed, associated tag rankings, and inter relationships.

### BACKGROUND

In the field of data management and security, detecting anomalous behaviour exhibited by actors whether human users or machine agents is a critical yet technically complex challenge. For instance, enterprise systems and cloud-based platforms may include highly interconnected environments where actors interact with a wide range of digital entities such as electronic devices, structured databases, configuration files, unstructured logs, or user-accessible resources. The interactions are rarely uniform or static and instead, exhibit session-wise variability, role-dependent patterns, and temporal shifts in the access behaviours of the actors. Traditional anomaly detection techniques rely heavily on predefined thresholds or behavioural baselines that do not account for the dynamic and context-sensitive nature of modern actor behaviour.

A key technical challenge arises from the lack of contextual awareness in the existing techniques. Most traditional techniques monitor activities at the level of isolated events or fixed sequences, without modelling the multi-dimensional behavioural context that evolves over time. For example, accessing a sensitive file at a certain time may or may not be anomalous depending on the actor's role, device, access history, or co-accessed resources. However, the existing techniques lacks the capacity to contextualize such actions across sessions, leading to either false positives or undetected anomalies. Moreover, the inherent characteristics of the entities being accessed such as sensitivity, data type, lineage, or access privilege level are often ignored or treated as static attributes without assessing their changing significance in behavioural interpretation.

Another technical limitation of the existing techniques lies in the inability to model temporal variations and behavioural drifts. In certain dynamic environments, the actor's behaviour cannot be captured as a fixed template or baseline. Rather, the actor's behaviour changes due to factors such as task shifts, operational changes, permission escalations, or compromise attempts. The existing techniques typically treat each actor session in isolation or assume static references that do not evolve, consequently failing to detect stealthy behavioural deviations (i.e., anomaly).

Further, the existing techniques often operate as black-box models, with limited interpretability or explainability. When the anomaly is detected, the existing techniques cannot isolate which dimensions of behaviour contributed to the anomaly, or deviations of the dimensions from normal behaviour. Thus, lack of transparency not only reduces operational trust but also hinders analysts from responding effectively. Systems that do offer anomaly scoring seldom provide mechanisms to simulate or probe the actor's behavioural context by masking or modifying certain input dimensions to identify localized anomalies.

Moreover, the existing techniques do not provide mechanisms to adapt and evolve their internal models based on real-time feedback.

There remains a need for an effective system and method for automated anomaly detection.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

In an aspect of the present invention, a method for automated anomaly detection of one or more actors is disclosed. The method includes identifying one or more characteristics associated with a plurality of entities accessed by the one or more actors. Further, the method includes assigning one or more task-specific ranks to the one or more characteristics based on contextual importance. The one or more task-specific ranks indicate a relevance association of each of the one or more characteristics to a behavioural outcome. Furthermore, the method includes contextualizing an actor behaviour over a plurality of sessions based on the one or more task-specific ranks. The actor behaviour indicates a set of access interactions and context patterns of the one or more actors. Furthermore, the method includes modelling context variations associated with the actor behaviour over the plurality of sessions. Furthermore, the method includes predicting an expected behaviour of the one or more actors based on masking the context variations. Furthermore, the method includes determining a deviation between the predicted expected behaviour and an actual behaviour of the one or more actors; Furthermore, the method includes detecting an anomaly based on the deviation.

In another aspect of the present invention, a system for automated anomaly detection of one or more actors is disclosed. The system includes a memory and at one processor. The at least one processor is configured to identify one or more characteristics associated with a plurality of entities accessed by the one or more actors. Further, the at least one processor is configured to assign one or more task-specific ranks to the one or more characteristics based on contextual importance. The one or more task-specific ranks indicate a relevance association of each of the one or more characteristics to a behavioural outcome. Furthermore, the at least one processor is configured to contextualize an actor behaviour over a plurality of sessions based on the one or more task-specific ranks. The actor behaviour indicates a set of access interactions and context patterns of the one or more actors. Furthermore, the at least one processor is configured to model context variations associated with the actor behaviour over the plurality of sessions. Furthermore, the at least one processor is configured to predict an expected behaviour of the one or more actors based on masking the context variations. Furthermore, the at least one processor is configured to determine a deviation between the predicted expected behaviour and an actual behaviour of the one or more actors; Furthermore, the at least one processor is configured to detect an anomaly based on the deviation.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an environment comprising a system for automated anomaly detection, in accordance with an embodiment of the present disclosure;

FIG. 2 illustrates a block diagram of the system for automated anomaly detection, in accordance with an embodiment of the present disclosure;

FIG. 3 illustrates a process flow depicting operations among a set of modules of the system, in accordance with an embodiment of the present disclosure; and

FIG. 4 illustrates a process flow depicting a method associated with the system for automated anomaly detection, in accordance with an embodiment of the present disclosure.

Further, skilled artisans will appreciate that elements in the drawings are illustrated for simplicity and may not have necessarily been drawn to scale.

Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION OF FIGURES

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in detail with reference to the accompanying drawings.

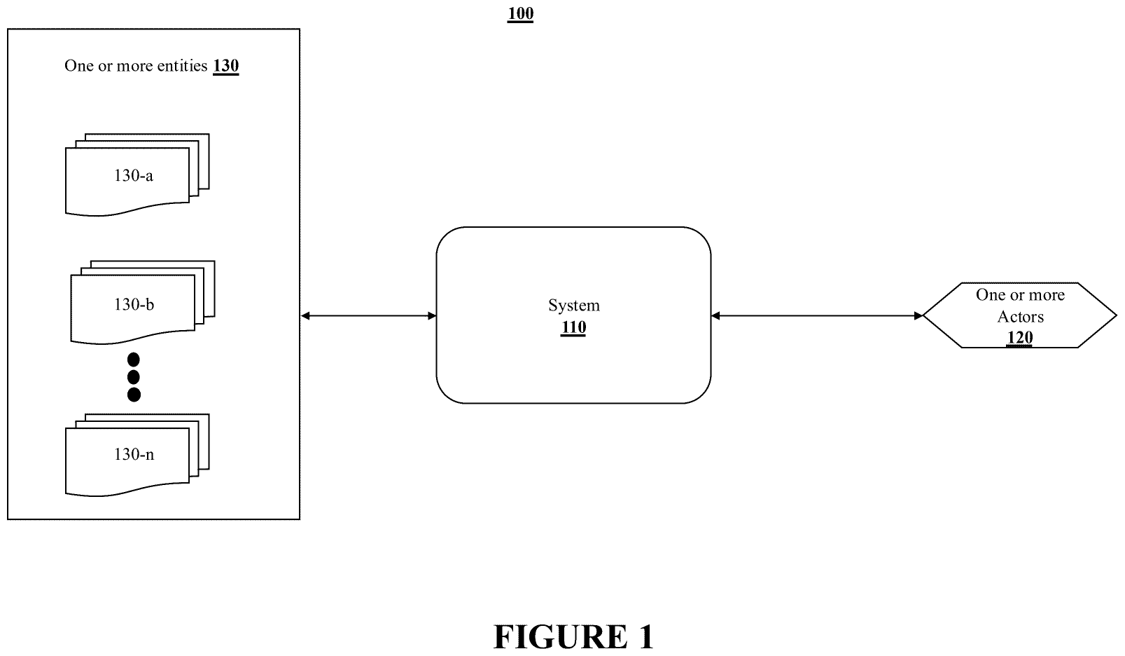

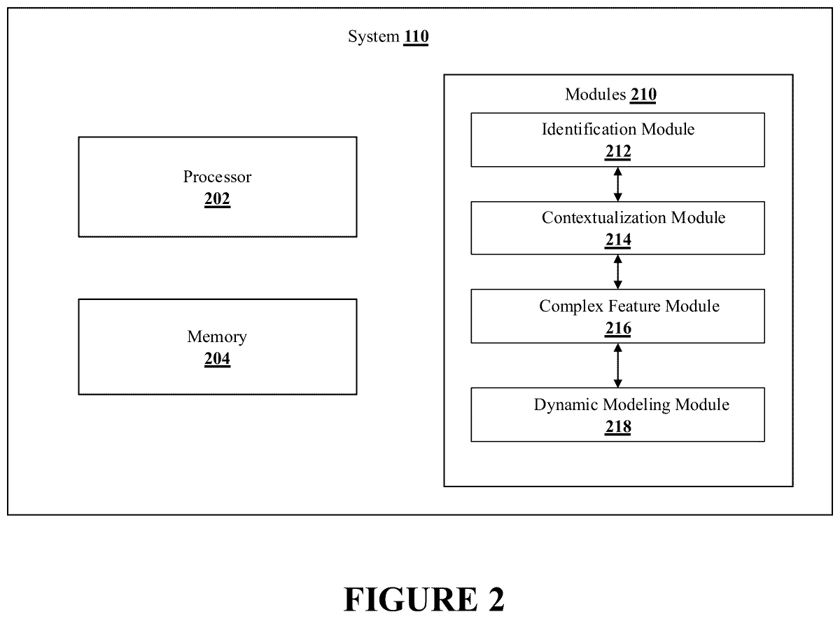

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

Following is the description of FIG. 1. Please include more paragraphs after the following description which should be based on claim 1 and should be in a continuous narrative form to the provided description of FIG. 1.

FIG. 1 illustrates a block diagram of an environment 100 comprising a system 110 for automated detection of anomalous behaviours. The system 110 may be communicably coupled with one or more actors 120 (referred to as actors 120 for the sake of brevity) and one or more entities 130 (130-a, 130-b, . . . 130-n) (referred to as entities 130 for the sake of brevity). The actors 120 may refer to accessors and/or requestors of the entities 130. In an embodiment, the actors 120 may include human users and machines. The actors 120 may be associated with corresponding electronic devices. The entities 130 may also be associated with corresponding electronic devices.

The system 110 may be configured to detect anomalous actor behaviour and identify anomalies in the environment 100. The system 110 may be configured to identify one or more characteristics (referred to as characteristics, for the sake of brevity) associated with the entities 130, contextualize actor behaviour over a period of time, determine context changes, and overlaps, and dynamically model context changes to detect anomalies. The entities 130 may refer to files, database records, and any configuration.

In an embodiment, the system 110 may be implemented in conjunction with one or more electronic devices, such as, electronic devices associated with the actors 120 or electronic devices associated with the entities 130. In another embodiment, the system 110 may be implemented in a cloud-based server. In such a scenario, the system 110 may be in communication with an electronic device via a communication network. The network may include a wired or a wireless network. The network may correspond to Wi-Fi, cellular networks such as 4G, 5G, 6G, or any other communication network.

In an embodiment, the system 110 may be configured to identify the characteristics associated with the entities 130 accessed by the actors 120. The characteristics may be derived from metadata, access policies, entity types, or inferred relationships. In an example, the characteristics may include, but are not limited to, sensitivity level, access class, data type, purpose, location, lineage, and provenance. In an advantageous aspect, the characteristics enable the system 110 to build an enriched understanding of the entities 130 being accessed, and consequently for evaluating the context of actor behaviour.

Further, once the characteristics are identified, the system 110 may be configured to assign one or more task-specific ranks (referred to as task-specific ranks for the sake of brevity) to each of the characteristics. The task-specific rank indicates a relevance association of each of the characteristics to a behavioural outcome. For example, if an entity's sensitivity level is determined to have a strong influence on risk-based behaviour deviation, then the entity's sensitivity level may be assigned a higher rank than other attributes such as location. Thus, assigning the task-specific ranks may consider multiple factors, such as the recency of tag association, frequency of usage, semantic alignment with actor roles or actions, and statistical correlation with observed anomalies.

Furthermore, the system 110 based on assigning the task-specific ranks to the characteristics may be configured to contextualize the behaviour of the actor 120 over a plurality of sessions. In an example, the contextualization may refer to capturing behavioural data across different time intervals or the plurality of sessions, such as access sequences, request-response patterns, device or internet protocol (IP) information, temporal activity windows, and linked entity interactions. Thus, the historical behavioural trace is mapped against the assigned task-specific ranks to the characteristics consequently forming a structured and dynamic representation of the actor's 120 context.

In an embodiment, the system 110 models context variations associated with the actor behaviour over the plurality of sessions. The context variations may indicate shifts, expansions, or contractions in behavioural features across time such as a user accessing higher-sensitivity entities in later sessions, or altering the time-of-access pattern. In an example, the context variations may be quantified using one or more artificial intelligence (AI) models, which measure the rate and extent of change across multiple behavioural dimensions. In an advantageous aspect, the modelling of the context variations, the system 110 may be configured to detect behavioural drifts in the actor behaviour.

In an embodiment, the system 110 may be configured to apply a masking technique to the behavioural context representation. In an embodiment, the masking technique refers to masking a variable portion of a context vector that represents the actor's behavioural (or behavioural attributes) influenced by the context variations, particularly temporal context variations. Further, the system 110 may be configured, using an AI model, to predict an expected behaviour corresponding to the masked portion, based on a remaining unmasked portion. In an advantageous aspect, thus, the system 110 estimates the actor's behaviour in normal conditions.

After the expected behaviour is predicted, the system 110 may be configured to determine a deviation between the predicted expected behaviour and an actual behaviour observed in the same context variation. The deviation may be quantified based on measuring a difference between predicted and actual context vectors or outputs, and a degree of deviation serves may correspond to an indicator of abnormality.

In an embodiment, the system 110 may be configured to determine if the deviation exceeds a predefined threshold and thus accordingly detects the anomaly. The detection may include identifying one or more behavioural segments responsible for the deviation and classifying the one or more behavioural segments as anomalous. In an advantageous aspect, the system 110 base don the classification not only detects an unusual occurrence but also pinpoints the temporal or contextual region responsible for it.

In an example scenario, the system 110 may be implemented to monitor employee access to internal data repositories. In this scenario, the actors 120 may correspond to multiple employees, such as a finance analyst titled user-A, capable of accessing various financial and personnel-related files (i.e., the entities 130) during the course of her work.

Further, in the example scenario, based on day-to-day operations, user-A accesses a consistent set of entities 130, such as quarterly budget spreadsheets, payroll summaries, and vendor invoices. Thus the entities 130 is associated with the characteristics such as data type (spreadsheet and document), sensitivity level (internal and confidential), access class (read-only), purpose (financial analysis), and location (stored in internal finance server). The system 110 identifies these characteristics and builds a behavioural profile for the user-A over a span of several weeks (i.e., the plurality of sessions).

As user-A continues her work, the system 110 assigns the task-specific ranks to each of the characteristics. For instance, the sensitivity level and the access class may be ranked higher for their predictive significance in financial roles, whereas location might receive a lower rank.

Furthermore, in the example scenario, the system 110 contextualizes the actor behaviour (of user-A) across multiple sessions. Patterns such as accessing budget files every Monday morning, performing read-only queries from a corporate electronic device, and retrieving files of specific size limit from the internal server. Advantageously, the contextualization forms a temporal vector of normal activity.

Furthermore, in the example scenario, the system 110 determines the context variation in some instances. For instance, user-A initiates a request from a different geographic location, accesses files with the tag “classified”, uses a write-enabled access path, and performs a bulk export of data from a personnel repository. This context variation deviates from the past behaviour (i.e., the actual behaviour) of the user-A, including both access scope and entity characteristics. The system 110 models the context variations (i.e., the changes) using the AI model trained to quantify the deviations in session-specific behaviour.

Furthermore, in the example scenario, the system 110 masks portions of the the context variations i.e., the user-A's behavioural context vector such as, access time, file sensitivity, and access path. Further, predicting the expected behaviour of an employee (the actor) in her role under normal conditions. If the predicted expected behaviour does not match the actual behaviour, resulting in a deviation or determining a high deviation score.

Consequently, based on the deviation or the high deviation score between the predicted and actual behaviours, the system 110 identifies a segment of the session as anomalous e.g., access to the “classified” files through a write-enabled connection from an unrecognized location and classifies the segment as the source of abnormality.

In an embodiment, an explainer sub-module of the system 110 may be configured to generate a natural language output. In the example scenario, the generated natural language output may be:
“Anomaly detected: user-A accessed classified files using write access from an unrecognized location, deviating from historical read-only patterns associated with internal finance data.”

In the example scenario, thus, the generated natural language output advantageously helps security analysts understand the cause of the alert, enabling swift and informed decision-making.

FIG. 2 illustrates a block diagram of the system 110 depicted in FIG. 1. The system 110 includes one or more processors 202 (alternatively referred to as a ‘processor 202’) and a memory 204. As a non-limiting example, the one or more processors 202 are a single processing unit or a set of units each including multiple computing units. The one or more processors 202 are implemented as one or more microprocessors, microcomputers, microcontrollers, digital signal processors, central processing units, state machines, logic circuitries, and/or any devices that manipulate signals based on operational instructions (computer-readable instructions) stored in the memory 204. Among other capabilities, the one or more processors 202 are configured to fetch and execute computer-readable instructions and data stored in the memory 204. The one or more processors 202 include one or a plurality of processors. The plurality of processors are further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). The plurality of processors control the processing of the input data in accordance with a predefined operating rule or an artificial intelligence (AI) model stored in the memory 204. The predefined operating rule or the AI model is provided through training or learning.

The one or more processors 202 are disposed in communication with one or more input/output (I/O) devices via an Input/Output (I/O) interface. The I/O interface employs communication code-division multiple access (CDMA), high-speed packet access (HSPA+), global system for mobile communications (GSM), long-term evolution (LTE), WiMax, or the like, etc. In another embodiment of the present invention, the I/O interface employs ethernet, industrial wireless Local Area Network (LAN), Process Field Bus (PROFIBUS), Actuator Sensor (AS) Interface, and the like.

In some embodiments, the memory 204 is communicatively coupled to the one or more processors 202. The memory 204 is configured to store instructions executable by the one or more processors 202. In one embodiment, the memory 204 communicates via a bus within the system 110. The memory 204 includes, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory includes a cache or random-access memory (RAM) for the one or more processors 202.

In alternative examples, the memory 204 is separate from the one or more processors 202 such as a cache memory of a processor, the system memory, or other memory. The memory 204 is an external storage device or a datastore for storing data. The memory 204 is operable to store instructions executable by the one or more processors 202. The functions, acts or tasks illustrated in the figures or described are performed by the programmed processor for executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies include multiprocessing, multitasking, parallel processing, and the like.

The memory 204 may include an operating system for performing one or more tasks of the system 110, as performed by a generic operating system in the communications domain. In one embodiment, the memory 204 is configured to store the information as required by the one or more processors 202 to perform one or more functions for validating accessors based on data access language patterns and query execution analysis.

The system 110 further comprises a set of modules 210. The processor 202 may be configured to perform designated functions in conjunction with the memory 204 and the set of modules 210. In some embodiments, the set of modules 210 may be included within the memory 204. In some embodiments, the set of modules 210 may include a set of instructions that may be executed to cause the system 110, in particular, the processor 202, to perform any one or more of the methods disclosed herein. The set of modules 210 in conjunction with the processor 202 may be configured to perform the steps of the present disclosure using the data stored in the memory 204, as discussed throughout this disclosure. In an embodiment, each of the set of modules 210 may be software modules within the memory 204. In an embodiment, each of the set of modules 210 may be hardware units that may be outside the memory 204.

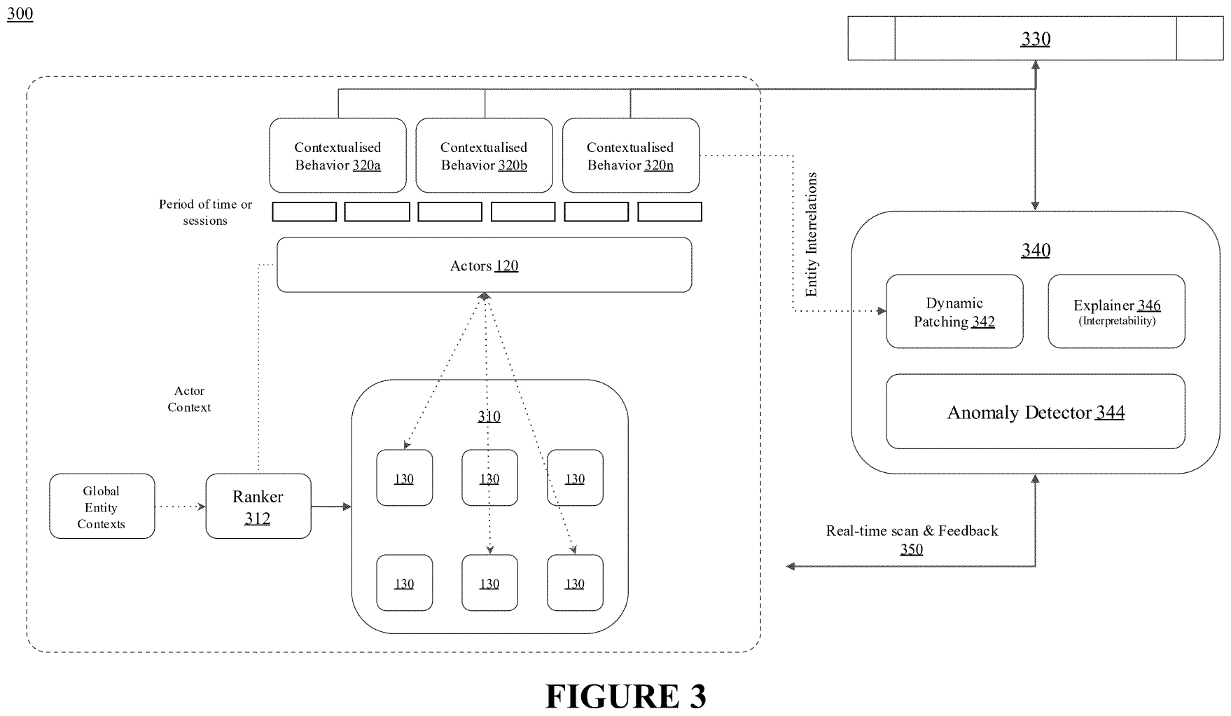

FIG. 3 illustrates a process flow 300 depicting operations among the set of modules 210 of the system 110. The set of modules 210 may include an identification module 212, a contextualization module 214, a complex feature module 216, and a dynamic modeling module 218, in communication with each other.

At block 310, the processor 202 in conjunction with the identification module 212 may be configured to identify the characteristics (e.g. the inherent characteristics) associated with the entities 130, i.e., the accessed entities. In an embodiment, the inherent characteristics associated with the entities 130 may include tags such as sensitivity level (classified, public, etc.), access class (read-only, write, etc.), data types, purpose, location, and other metadata. In an embodiment, the inherent characteristics may include relationships and dependencies. In an embodiment, the inherent characteristics may include lineage and provenance, wherein origin and interactions of the entities 130 may reveal dependencies and potential vulnerabilities. Thus, the identification module 212 may be configured to identify the characteristics based on determining the tags.

In an embodiment, the characteristics or tags may be assigned the task-specific ranks or contextualized based on one or more global factors (global entity context) or actor-based factors (actor context), as depicted by a ranker at block 312. This facilitates the enhancement of the precision of anomaly detection. In an embodiment, the global or actor-based factors include
Data relevance to user role: Accessing irrelevant data points compared to a user's typical tasks could signal suspicious behaviour.
Temporal Relevance: Accessing outdated or time-sensitive data outside expected windows might be anomalous.
Associated Access Privilege: The level of permission required to access the entity (admin, user).
Business Impact: The potential disruption caused by unauthorized access to specific data (e.g., customer records, financial data).
System constraints such as database constraints.
Freshness: Recent access can expose attempts to access outdated or potentially manipulated information.
Mutability.
Rate of access (number of records fetched).
Inferred confidentiality (e.g. semantic inference techniques can be used to infer confidentiality levels based on the entity name or associated metadata).
External threat intelligence: Integrating threat feeds to identify tags associated with known vulnerabilities or attack vectors.
Perceived or actual anomalous past behaviour of a user over a given resource.
Impact radius to consider possible ripple effects of a security breach. The impact radius can be calculated based on interactions with other entities (frequency of the accessed entity being used in conjunction with other entities (e.g., through joins in a database)), frequency of interactions (frequent access to sensitive entities, even with proper authorization, may indicate requirement of further investigation when deviating from established patterns), weighted importance of linked entities (i.e., assigning higher weight to entities known to be critical or interconnected within the system), and historical breach statistics (analysis of past breaches to identify entities that were commonly targeted).

In an embodiment, the ranker is a ‘Task-specific’ importance associator with the tags or the characteristics. The ranker may act as a sub-module configured to assign the task-specific ranks based on be pre-defined criteria or derived dynamically based on factors such as:
Temporal Dynamics: for instance, recency of tag association, decay-weighted association score, volatility and stability over time, and change-point detection impact
Confidence & Strength of Association: for instance, confidence of tag assignment, actor/resource-tag affinity, frequency, and consistency of usage.
Task-Relevance & Semantic Alignment: for instance, task relevance score, semantic proximity to task, tag embedding similarity, and task-state alignment
Behavioral & Contextual Signals: for instance, co-occurrence with specific behaviors or outcomes, and usage diversity across actors/resources.
Statistical & Graph-Based Properties: discriminative power across tag space and correlation with risk or role patterns

In an advantageous aspect, assigning the task-specific may help eliminate inferior tags or characteristics.

In an embodiment, the identification module 212 may be configured to determine ranking scores based on at least one of a recency of tag association, a volatility of entity usage over time, a frequency of actor interaction, a semantic proximity, and statistical correlation with behavioural outcomes and consequently assign the task-specific ranks, using the ranker, based on the ranking scores.

The contextualization module 214 in conjunction with the processor 202 may be configured to contextualize actor behaviour, as depicted at blocks 320a-320n, over the plurality of sessions. The actor behaviour may be contextualized once the identification, linkage (through lineage), and ranking of the characteristics associated with the one or more entities 130. The actor behaviour may be considered over a period of time periods or sessions. In an example, the actor behaviour indicates a set of access interactions and context patterns of the actors in the environment 100.

In an embodiment, the contextualization encompasses aggregating behavioural data over the plurality of sessions, including but not limited to, user characteristics (e.g. user group, role, access pathway taken, etc.), the entities accessed, entity tags, tag ranks, frequent co-occurring entities in request or response, access request characteristics (context, i.e., preceding and following requests, parameters and filters, etc.), response characteristics (e.g. rows returned, execution plan, TTL, format), temporal facts (such as time of access, frequency of access, and time gap between access), tags, access characteristics (e.g. method of access, device, IP, location, assumed role). Further, the contextualization module 214 may be configured to obtain entities and linked actions occurring within a networked environment or surrounding the given entity as well as externally.

At block 330, the processor 202 in conjunction with the complex feature module 216 may be configured to measure context changes and overlaps, and further, quantify the dynamics of the actor behaviour using one or more Artificial Intelligence (Al) and/or Machine Learning (ML) models. In an embodiment, multiple predefined context factors such as context expansion rate, context shrink rate, context changing patterns, context overlaps, rate of change in Context overlaps may be measured. In an embodiment, the multiple factors may be measured over the period of time periods or sessions. Advantageously, facilitating more effective anomaly detection.

At block 340, the processor 202 in conjunction with the dynamic modeling module 218 may be configured to dynamically model the changes in actor behaviour over time. In an embodiment, the evolution of contextual patterns may be analyzed to identify deviation from normal behaviour. In a non-limiting example, the dynamic modeling module 218 may be configured to monitor evolving behaviour, continuously update the representations, and also perform dynamic patching.

In an embodiment, the dynamic modeling module 218 may be configured to identify a predefined context factors in the actor behaviour over the plurality of sessions. Further, the dynamic modeling module 218 may be configured to quantify a rate of change in the predefined context factors and consequently model the context variation, using an artificial intelligence (AI) models. The context variations may be modelled based on the rate of change and thus refers to temporal deviations in the behavioural context of the actors 120.

In an embodiment, the dynamic modeling module 218 may be configured to perform the dynamic patching, as depicted at block 342. In an embodiment, the dynamic modeling module 218 may be configured to mask the proportions of the context and predict the same based on the remaining context. The dynamic patching based on inter-relationships facilitates thus making the system interpretable by means of an explainer sub-module 346, and further, the system is robust to understand complex inter-relationships.

In an example, the dynamic patching may refer to marking a region for which values are to be determined based on an existing behavioural model (deep learning model or otherwise). The patch where predicted and actual may have high deviations and consequently may be assumed to be points of the anomaly. Thus, varying the proportions of patching, and changing the constrained parts, may help in accurate pin pointing of an anomalous region or the segment.

In an embodiment, the proportions of the context to be masked may be variable. In an embodiment, the proportion of the patching may successively increase, decrease, or constrain specific parts to understand the inter-relationship strengths and localize the anomalous portions. The anomalies can thus be detected, as depicted at block 344.

In the embodiment, the dynamic modeling module 218 may be configured to mask a variable portion of the context vector indicating the actor behaviour. The variable portion may indicate behavioural attributes influenced by the temporal context variations. Consequently, the dynamic modeling module 218 may be configured to predict the expected behaviour corresponding to the masked variable portion, using an AI model, based on a remaining unmasked portion.

Further, the dynamic modeling module 218 may be configured to determine the deviation between the predicted and actual behaviours of the actors 120. The he dynamic modeling module 218 may be configured to identify the segment of the actor behaviour where the deviation may exceed the predefined threshold. Consequently, at block 344 the dynamic modeling module 218 may be configured to classify the identified segment as anomalous or the anomaly based on the deviation.

In an embodiment, the models employed in the system 110 may be adapted and refined based on feedback. That is, feedback mechanisms at block 350 may be employed and continuous entity characteristic identification, ranking, and monitoring of actor behaviour change may be incorporated in the feedback. The refinement may be done in real-time, ensuring robustness against emerging threats and evolving attack vectors.

In the embodiment, the processor 202 may be configured to receive feedback indicating a relevance of the anomaly and subsequently update the characteristics, the task-specific ranks, and the context variations based on the feedback.

In an embodiment, the processor 202, via the explainer sub-module 346, may be configured to generate the explanation for the anomaly based on identifying a minimal set of characteristics of the deviation. The explanation includes the natural language output based on intersecting results of multiple masked predictions.

The system 110 thus provides an approach for modeling actor behaviour and identifying anomalies by identifying and ranking the characteristics, contextualization of actor behaviour over a period of time or sessions, checking context overlaps, and dynamic modeling of context changes to detect anomalies.

In an embodiment, the system 110 further includes evaluating one or more errors made by an AI model configured to detect anomalies during training on a labelled dataset. The training dataset may include the actor behaviour labelled as either normal or anomalous. During the training phase, the AI model may incorrectly classify some samples for instance incorrectly classifying a benign behaviour as anomalous (e.g. false positive), or failing to flag a true anomaly (e.g. false negative). The incorrect classifications corresponds to the AI model's error profile during training.

Thus, based on the identified one or more errors, the system 110 may be configured to generate at least one of a temporal (such as but not limited to a time series) or a multi-dimensional pattern representations (such as but not limited to clustering) that represents the error pattern. The temporal pattern representation may capture the frequency, context, or temporal recurrence of specific misclassifications over training sessions. The multi-dimensional pattern representation may group similar errors based on feature space proximity or similarity of context (e.g., user role, time of access, entity type). The error representations (i.e., temporal or multi-dimensional pattern representations) collectively indicate an error pattern or error signature of the AI model configured to detect the anomaly.

Consequently, the system 110 may be configured to characterize the error behaviour of the AI model based on either re-training the AI model using the error representations, or based on training a separate secondary AI model dedicated to modelling the error patterns. In an example, the secondary AI model may be configured to capture or characterize the scenarios or conditions under which the primary anomaly detection model (i.e., the AI model) tends to underperform or classify incorrectly. Advantageously, the characterization may serve as a statistical and contextual baseline of the AI model weakness.

Consequently, in real-time, the characterized error behaviour may be used to suppress false alarms. In an example, when the AI model (i.e., for the anomaly detection) generates an anomaly alert, the system 110 compares the result against the characterized error behaviour. If the current detection context matches a known error pattern previously seen during the training, the system 110 may suppress the alert, thus considering the alert as a likely false positive. Conversely, if the anomaly is dissimilar to prior error patterns, the alert is retained and may be escalated for human review. Advantageously, improving trust in the system 110 for the anomaly detection while reducing alert fatigue.

In an example scenario, an administrator (User X) of a system routinely performs batch queries on internal financial databases during the last week of each month. During training, the AI model (i.e., the primary) for the anomaly detection may mistakenly flagged the queries as anomalous say due to a spike in frequency or size. The training-time false positives were captured and encoded into the time series for error representing the AI model's elevated alert rate during monthly end-periods.

The secondary AI model when trained using the time series for error to characterize the error behaviour may effectively learn that the primary AI model tends to over-alert during predictable, spike periods associated with specific user roles and times.

In the example scenario, when the User X initiates a similar batch query at the end of the next month. The primary AI model again flags this as anomalous. However, before raising an alert, the system 110 compares the recent detection against the characterized error behaviour. Consequently, the presence of a strong match with known training-time false positives, the system 110 may suppresses the alert, recognizing the alert as a recurring, behavioural spike rather than a real anomaly. Advantageously, the selective suppression avoids unnecessary investigation while maintaining the integrity of the anomaly detection.

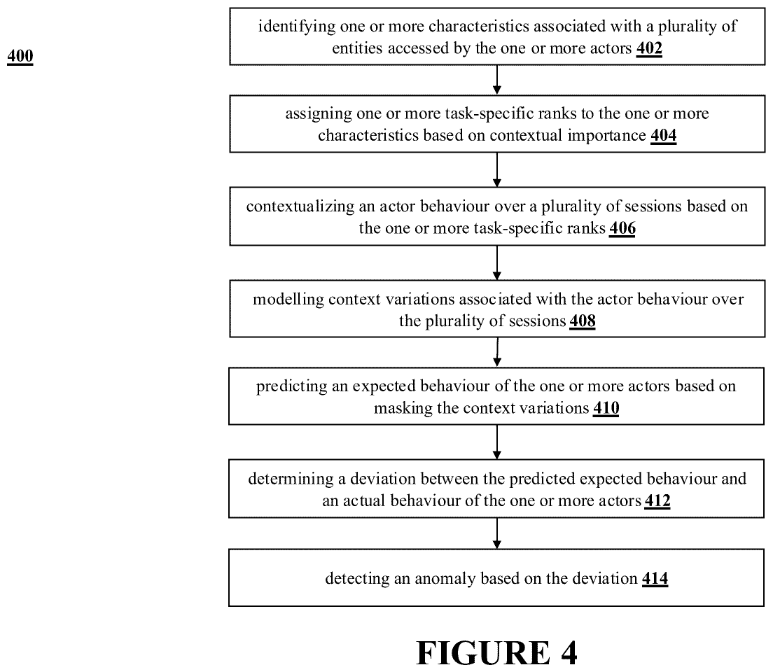

FIG. 4 illustrates a process flow depicting a method 400 associated with the system 110 for automated detection of anomalous behaviours. The method 400 may be performed by the system 110, in particular, with the processor 202 in conjunction with the modules 210.

At block 402, the method 400 includes identifying the characteristics associated with the entities 130 accessed by the actors 120.

At block 404, the method 400 includes assigning the task-specific ranks to the characteristics based on contextual importance. The task-specific ranks indicate the relevant association of each of the characteristics to the behavioural outcome.

At block 406, the method 400 includes contextualizing the actor behaviour over the plurality of sessions based on the task-specific ranks. The actor behaviour indicates the set of access interactions and context patterns of the one or more actors.

At block 408, the method 400 includes modelling the context variations associated with the actor behaviour over the plurality of sessions.

At block 410, the method 400 includes predicting the expected behaviour of the actors based on masking the context variations.

At block 412, the method 400 includes determining the deviation between the predicted expected behaviour and the actual behaviour of the actors 120.

At block 414, the method 400 includes detecting the anomaly based on the deviation.

It is to be noted that the details involved in the steps of the method have been detailed with reference to FIGS. 1-3 and have not been repeated herein for the sake of brevity.

In an embodiment, the system 110 is provided in a distributed manner, in that, one or more components and/or functionalities of the system 110 are provided through an electronic device, and one or more components and/or functionalities of the system 110 are be provided through a cloud-based unit, such as, a cloud storage or a cloud-based server. In a non-limiting example, the memory 204 may be provided through the cloud storage and the one or more processors 202 may be integrated with an electronic device.

Further, the present invention also contemplates a computer-program product that includes instructions or receives and executes instructions responsive to a propagated signal. Further, the instructions may be transmitted or received over the network via a communication port or interface or using a bus (not shown). The communication port or interface may be a part of the one or more processors 202 or may be a separate component. The communication port may be created in software or may be a physical connection in hardware. The communication port may be configured to connect with the network, external media, the display, or any other components in the system 110. The connection with the network may be a physical connection, such as a wired ethernet connection, or may be established wirelessly. Likewise, the additional connections with other components of the system 110 may be physical or may be established wirelessly. The network may alternatively be directly connected to the bus. For the sake of brevity, the architecture, and standard operations of the memory 204 and the one or more processors 202 are not discussed in detail.

In an embodiment, the computer-program product, having machine-readable instructions stored therein, when executed by one or more processors 202, cause the one or more processors 202 to perform a method as elaborated in subsequent paragraphs at least with reference to FIG. 4.

Further, the present invention also contemplates a non-transitory computer-readable medium encoded with executable instructions. The executable instructions, when executed by one or more processors 202, cause the one or more processors 202 to perform a method as elaborated in subsequent paragraphs at least with reference to FIG. 4. Examples of computer-readable mediums include non-volatile, hard-coded type mediums such as read-only memories (ROMs) or erasable, electrically programmable read-only memories (EEPROMs), and user-recordable type mediums such as floppy disks, hard disk drives and compact disk read-only memories (CD-ROMs) or digital versatile disks (DVDs).

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

It will be appreciated that the modules, processes, systems, and devices described above can be implemented in hardware, hardware programmed by software, software instruction stored on a non-transitory computer readable medium or a combination of the above. Embodiments of the methods, processes, modules, devices, and systems (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the methods, systems, or computer program products (software program stored on a non-transitory computer readable medium).

Furthermore, embodiments of the disclosed methods, processes, modules, devices, systems, and computer program product may be readily implemented, fully or partially, in software using, for example, object or object-oriented software development environments that provide portable source code that can be used on a variety of computer platforms. Alternatively, embodiments of the disclosed methods, processes, modules, devices, systems, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the invention to produce additional embodiments. Furthermore, certain features may sometimes be used to advantage without a corresponding use of other features.

We claim:

1. A method for automated anomaly detection of one or more actors, the method comprising:
identifying one or more characteristics associated with a plurality of entities accessed by the one or more actors;
assigning one or more task-specific ranks to the one or more characteristics based on contextual importance, wherein the one or more task-specific ranks indicate a relevance association of each of the one or more characteristics to a behavioural outcome;
contextualizing an actor behaviour over a plurality of sessions based on the one or more task-specific ranks, wherein the actor behaviour indicates a set of access interactions and context patterns of the one or more actors;
modelling context variations associated with the actor behaviour over the plurality of sessions;
predicting an expected behaviour of the one or more actors based on masking the context variations;
determining a deviation between the predicted expected behaviour and an actual behaviour of the one or more actors; and
detecting an anomaly based on the deviation.

2. The method as claimed in claim 1, wherein identifying the one or more characteristics associated with the plurality of entities comprises:
determining tags indicating at least one of sensitivity level, access class, data type, purpose, location, lineage, provenance, or metadata for each of the plurality of entities; and
identifying the one or more characteristics based on the determination.

3. The method as claimed in claim 2, wherein the one or more characteristics further comprise one or more inter-entity relationships, dependency links, access lineage, and provenance trails.

4. The method as claimed in claim 1, wherein assigning the one or more task-specific ranks to the one or more characteristics comprises:
determining ranking scores based on at least one of a recency of tag association, a volatility of entity usage over time, a frequency of actor interaction, a semantic proximity, and statistical correlation with behavioural outcomes; and
assigning the one or more task-specific ranks based on the ranking scores.

5. The method as claimed in claim 1, wherein contextualizing the actor behaviour comprises:
aggregating behavioural data over the plurality of sessions, the behavioural data comprising access pathway, user role or group, type and sequence of access requests, response characteristics, and temporal access patterns;
obtaining entities and linked actions occurring within a networked environment; and
contextualizing the actor behaviour based on correlating the behavioural data, entities, and linked actions.

6. The method as claimed in claim 1, wherein modelling the context variations comprises:
identifying a predefined context factors in the actor behaviour over the plurality of sessions;
quantifying a rate of change in the predefined context factors; and
modelling the context variation, using an artificial intelligence (AI) models, based on the rate of change, wherein the context variation indicates temporal deviations in the behavioural context of an actor.

7. The method as claimed in claim 1, wherein predicting the expected behaviour comprises:
masking a variable portion of a context vector indicating the actor behaviour, wherein the variable portion indicates one or more behavioural attributes influenced by temporal context variations; and
predicting the expected behaviour corresponding to the masked variable portion, using an AI model, based on a remaining unmasked portion.

8. The method as claimed in claim 1, wherein detecting the anomaly comprises:
determining a deviation between the predicted and actual behaviours of the one or more actors;
identifying a segment of the actor behaviour where the deviation exceeds a predefined threshold; and
classifying the identified segment as anomalous.

9. The method as claimed in claim 8, further comprising:
generating an explanation for the anomaly based on identifying a minimal set of characteristics of the deviation.

10. The method as claimed in claim 11, wherein the explanation comprises a natural language output based on intersecting results of multiple masked predictions.

11. The method as claimed in claim 1, further comprising:
receiving feedback indicating a relevance of the anomaly; and
updating the one or more characteristics, the one or more task-specific ranks, and the context variations based on the feedback.

12. The method as claimed in claim 1 further comprising:
evaluating, during training on a labelled dataset, one or more errors of an AI model configured to detect the anomaly;
generating at least one of a temporal or a multi-dimensional pattern representations indicating an error representation based on the one or more errors;
characterizing error behaviour of the AI model when re-trained using the at least one of the temporal or the multi-dimensional pattern representations; and
suppressing false alarms, using the re-trained AI model during a real-time anomaly detection based on comparing a current anomaly detection result against the characterized error behaviour.

13. A system for automated anomaly detection of one or more actors, the system comprising:
a memory;
at least one processor in communication with the memory, the at least one processor configured to:
identify one or more characteristics associated with a plurality of entities accessed by the one or more actors;
assign one or more task-specific ranks to the one or more characteristics based on contextual importance, wherein the one or more task-specific ranks indicate a relevance association of each of the one or more characteristics to a behavioural outcome;
contextualize an actor behaviour over a plurality of sessions based on the one or more task-specific ranks, wherein the actor behaviour indicates a set of access interactions and context patterns of the one or more actors;
model context variations associated with the actor behaviour over the plurality of sessions;
predict an expected behaviour of the one or more actors based on masking the context variations;
determine a deviation between the predicted expected behaviour and an actual behaviour of the one or more actors; and
detect an anomaly based on the deviation.

14. The system as claimed in claim 13, wherein to identify the one or more characteristics associated with the plurality of entities, the at least one processor is configured to:
determine tags indicating at least one of sensitivity level, access class, data type, purpose, location, lineage, provenance, or metadata for each of the plurality of entities; and
identify the one or more characteristics based on the determination.

15. The system as claimed in claim 14, wherein the one or more characteristics further comprise one or more inter-entity relationships, dependency links, access lineage, and provenance trails.

16. The system as claimed in claim 13, wherein to assign the one or more task-specific ranks to the one or more characteristics, the at least one processor is configured to:
determine ranking scores based on at least one of a recency of tag association, a volatility of entity usage over time, a frequency of actor interaction, a semantic proximity, and statistical correlation with behavioural outcomes; and
assign the one or more task-specific ranks based on the ranking scores.

17. The system as claimed in claim 13, wherein to contextualize the actor behaviour, the at least one processor is configured to:
aggregate behavioural data over the plurality of sessions, the behavioural data comprising access pathway, user role or group, type and sequence of access requests, response characteristics, and temporal access patterns;
obtain entities and linked actions occurring within a networked environment; and
contextualize the actor behaviour based on correlating the behavioural data, entities, and linked actions.

18. The system as claimed in claim 13, wherein to model the context variations, the at least one processor is configured to:
identify a predefined context factors in the actor behaviour over the plurality of sessions;
quantify a rate of change in the predefined context factors; and
model the context variation, using an artificial intelligence (AI) models, based on the rate of change, wherein the context variation indicates temporal deviations in the behavioural context of an actor.

19. The system as claimed in claim 13, wherein to predict the expected behaviour, the at least one processor is configured to:
mask a variable portion of a context vector indicating the actor behaviour, wherein the variable portion indicates one or more behavioural attributes influenced by temporal context variations; and
predict the expected behaviour corresponding to the masked variable portion, using an AI model, based on a remaining unmasked portion.

20. The system as claimed in claim 13, wherein to detect the anomaly, the at least one processor is configured to:
determine a deviation between the predicted and actual behaviours of the one or more actors;
identify a segment of the actor behaviour where the deviation exceeds a predefined threshold; and
classify the identified segment as anomalous.
